(19) United States
(12) Patent Application Publication
(10) Pub. No.: US 2010/0022178 A1
(43) Pub. Date: Jan. 28, 2010

(54) Vehicular air conditioning apparatus and air conditioning method

(75) Inventor: Akira Yamaguchi, Chiryu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/460,560

(22) Filed: Jul. 21, 2009

(30) Foreign Application Priority Data
Jul. 22, 2008 (JP) 2008-188905

(51) Int. Cl. B60H 1/22; G05D 7/00

(52) U.S. Cl. 454/159; 700/282

(57) ABSTRACT

A control unit of a vehicular air conditioning apparatus calculates a front target temperature, a rear target temperature, and a reference air volume level based on a deviation between the front target temperature and the rear target temperature. The control unit further calculates a correction amount for correcting the reference air volume level based on a deviation between the front target temperature and the rear target temperature.

### CROSS REFERENCE TO RELATED APPLICATION

This application is based on Japanese Patent Application No. 2008-188905 filed on Jul. 22, 2008, the disclosure of which is incorporated herein by reference.

### FIELD OF THE INVENTION

The present invention relates to a vehicular air conditioning apparatus and an air conditioning method for a passenger compartment. More particularly, the present invention relates to an air conditioning apparatus and an air conditioning method, capable of producing conditioned air to be blown into a front air conditioning zone and a rear air conditioning zone of a passenger compartment at different temperatures.

### BACKGROUND OF THE INVENTION

For example, JP-A-2006-111176 describes a vehicular air conditioning apparatus in which a rear target temperature of air to be blown into a rear air conditioning zone is calculated, and an correction amount for correcting an air volume level of a blower is calculated based on the rear target temperature. The air volume level, which has been determined based on a front target temperature of air to be blown into a front air conditioning zone, is corrected in an increase manner based on the correction amount.

### SUMMARY OF THE INVENTION

In such an air conditioning apparatus, however, conditioned air is supplied to the front air conditioning zone at the volume level corrected based on the rear target temperature. Thus, a front seat passenger may feel uncomfortable.

The present invention is made in view of the foregoing matter, and it is an object of the present invention to provide a vehicular air conditioning apparatus and an air conditioning method, capable of improving an air-condition of the rear air conditioning zone without deteriorating an air-condition of the front air conditioning zone.

According to an aspect of the present invention, an air conditioning apparatus includes a duct, a blower for generating air into the duct, a heating device, a cooling device, a front conditioned air generating device, a rear conditioned air generating device, and a control unit for controlling the blower, the front conditioned air generating device and the rear conditioned air generating device. The heating device is disposed in the duct for generating heated air. The cooling device is disposed in the duct for generating cooled air. The front conditioned air generating device is disposed in the duct and configured to control a ratio of the heated air to the cooled air for generating a front conditioned air to be introduced into a front air conditioning zone of a passenger compartment. The rear conditioned air generating device is disposed in the duct and configured to control a ratio of the heated air to the cooled air for generating a rear conditioned air to be introduced into a rear air conditioning zone of the passenger compartment. The control unit calculates: a front target temperature, which is a target temperature of the front conditioned air; a rear target temperature, which is a target temperature of the second conditioned air; calculates a reference air volume level of the blower based on the front target temperature; and calculates a correction amount for correcting the reference air volume level based on a deviation between the front target temperature and the rear target temperature.

Because the reference air volume level is corrected by the correction amount in accordance with the conditions of the front target temperature and the rear target temperature, the volumes of air blown into the front air conditioning zone and the rear air conditioning zone are properly controlled. As such, an air conditioning feeling of the rear air conditioning zone improves without deteriorating an air conditioning feeling of the front air conditioning zone.

According to a second aspect of the present invention, an air conditioning apparatus includes a duct, a blower for generating air into the duct, a heating device, a cooling device, a front-right conditioned air generating device, a front-left conditioned air generating device, a rear-right conditioned air generating device, a rear-left conditioned air generating device, and a control unit for controlling the blower and the conditioned air generating devices. The heating device is disposed in the duct for generating heated air. The cooling device is disposed in the duct for generating cooled air. The front-right conditioned air generating device is disposed in the duct and configured to control a ratio of the heated air to the cooled air for generating a front-right conditioned air to be introduced into a right area of a front air conditioning zone of a passenger compartment. The front-left conditioned air generating device is disposed in the duct and configured to control a ratio of the heated air to the cooled air for generating a front-left conditioned air to be introduced into a left area of the front air conditioning zone. The rear-right conditioned air generating device is disposed in the duct and configured to control a ratio of the heated air to the cooled air for generating a rear-right conditioned air to be introduced into a right area of a rear air conditioning zone of the passenger compartment. The rear-left conditioned air generating device is disposed in the duct and configured to control the ratio of the heated air to the cooled air for generating a rear-left conditioned air to be introduced into a left area of the rear air conditioning zone. The control unit calculates: a front target temperature, which is a target temperature of the front-right conditioned air and the front-left conditioned air; a rear target temperature, which is a target temperature of the rear-right conditioned air and the rear-left conditioned air; calculates a reference air volume level of the blower based on the front target temperature; and calculates a correction amount for correcting the reference air volume level based on a deviation between the front target temperature and the rear target temperature.

Because the reference air volume level is corrected by the correction amount in accordance with the conditions of the front target temperature and the rear target temperature, the volumes of air blown into the right and left areas of the front air conditioning zone and the right and left areas of the rear air conditioning zone are properly controlled. As such, an air-conditioning feeling of the rear air conditioning zone improves without deteriorating an air-conditioning feeling of the front air conditioning zone.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic diagram of a vehicular air conditioning apparatus according to a first embodiment of the present invention;

FIG. 2 is a flowchart illustrating a basic routine of an automatic air conditioning control of the air conditioning apparatus according to the first embodiment;

FIG. 3 is a flowchart illustrating a procedure for calculating a correction air volume level (Vadi) of FIG. 2;

FIG. 4 is a diagram illustrating a relationship between a front target temperature and a reference air volume level according to the first embodiment;

FIG. 5 is a diagram illustrating a relationship between the front target temperature and a front air volume level correction term according to the first embodiment;

FIG. 6 is a diagram illustrating a relationship between a rear target temperature and a gain correction term according to the first embodiment;

FIG. 7 is a diagram illustrating a relationship between the rear target temperature and a rear air volume level correction term according to the first embodiment;

FIG. 8 is a flowchart illustrating a procedure for calculating a correction air volume level according to a second embodiment of the present invention;

FIG. 9 is a diagram illustrating a relationship between a deviation between a front target temperature and a rear target temperature and a gain correction term according to the second embodiment;

FIG. 10 is a schematic diagram of an air conditioning apparatus according to a third embodiment of the present invention;

FIG. 11 is a flowchart illustrating a basic routine of an automatic air conditioning control of the air conditioning apparatus according to the third embodiment; and

FIG. 12 is a diagram illustrating a relationship between a deviation between a front target temperature and a rear target temperature and a variable coefficient according to the third embodiment.

### DETAILED DESCRIPTION OF EXEMPLARY EMBODIMENTS

### First Embodiment

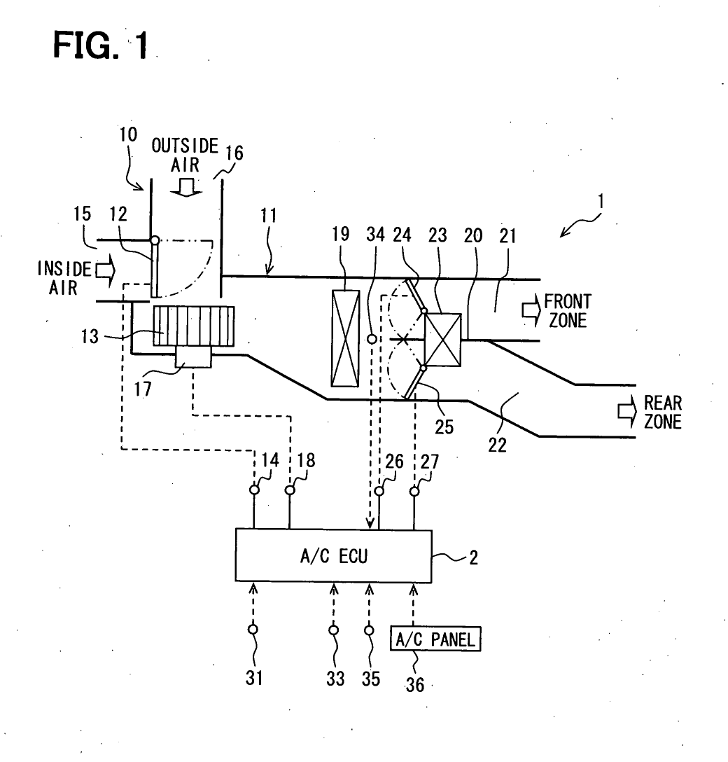

A first embodiment will now be described with reference to FIGS. 1 to 7.

An air conditioning apparatus is configured for controlling a passenger compartment of a vehicle, which has an engine. In the present embodiment, the vehicular air conditioning apparatus is configured such that the temperature of air blown toward a front air conditioning zone (front seat zone) and the temperature of air blown toward a rear air conditioning zone (rear seat zone) are independently controlled.

Referring to FIG. 1, the air conditioning apparatus generally includes an air conditioning unit (hereinafter, simply referred to as the a/c unit) 1 and an air conditioner ECU (hereinafter, simply referred to as the a/c ECU) 2 for controlling electric actuators of the a/c unit 1. The a/c unit 1 generally includes a blower unit 10 and an air conditioning duct 11 as a ventilation system.

For example, the blower unit 10 and the duct 11 are mounted in a lower portion of an instrument panel inside the passenger compartment. The duct 11 is located at a substantially middle position with respect to a vehicle right and left direction, and the blower unit 10 is offset from the duct 11 toward a front passenger seat side.

The blower unit 10 includes an inside/outside air switching door 12 and a blower 13. The door 12 is configured to control opening degrees of an inside air inlet 15 and an outside air inlet 16. The door 12 is driven by an actuator 14, such as a servomotor.

The inside air inlet 15 is an opening for introducing inside air from the inside of the passenger compartment. The outside air inlet 16 is an opening for introducing outside air from the outside of the presenter compartment. For example, the door 12 selectively opens and closes the inside air inlet 15 and the outside air inlet 16 in accordance with an air suction mode. In an inside air mode, the door 12 opens the inside air inlet 15. In an outside air mode, the door 12 opens the outside air inlet 16.

The blower 13 is provided for producing a flow of air in the duct 11. That is, the blower 13 suctions air from the inside air inlet 15 and the outside air inlet 16 and blows the air into an air-passage provided inside of the duct 11. The blower 13 is driven by a blower motor 17, which is controlled by a blower motor driving circuit 18. A rotational speed of the blower 13, such as an air volume level produced by the blower 13, is determined in accordance with an applied voltage (blower voltage) to the blower motor 17. Hereinafter, a unit of the blower 13 and the blower motor 17 is also referred to as the blower 13, 17.

An evaporator 19 is disposed at an upstream portion of the duct 11 for cooling air passing through the duct 11. That is, the evaporator 19 serves as a cooling device for generating cooled air. A separator 20 is provided in the duct 11 downstream, of the evaporator 19 to divide the air passage into a front zone air passage 21 and a rear zone air passage 22.

A downstream portion of the front zone air passage 21 is in communication with front ducts. The front ducts have a defroster outlet, front face outlets and front foot outlets at downstream locations thereof. The defroster outlet, the front face outlets and the rear foot outlet are disposed in the front air conditioning zone. As such, the front zone air passage 21 is in communication with the front air conditioning zone for blowing conditioned air into the front air conditioning zone.

A downstream portion of the rear zone air passage 22 is in communication with rear ducts. The rear ducts have rear face outlets and rear foot outlets at downstream locations thereof. The rear face outlets and the rear foot outlets are disposed in the rear air conditioning zone. As such, the rear zone air passage 22 is in communication with the rear air conditioning zone for blowing conditioned air into the rear air conditioning zone.

A heater core 23 is disposed in the front zone air passage 21 and the rear zone air passage 22 as a heating device for generating heated air. The heater core 23 performs heat exchange between an engine cooling fluid flowing inside thereof and the air passing through the front zone air passage 21 and the rear zone air passage 22, thereby to heat the air.

A front air mix door (FrA/M door) 24 is provided upstream of the heater core 23 in the front zone air passage 21. The front air mix door 24 is configured to control a volume ratio of the air introduced to the heater core 23 to the air bypassing the heater core 23 in the front zone air passage 21. In other words, the front air mix door 24 controls a ratio of the heated air to the cooled air in the front zone air passage 21. The front air mix door 24 serves as a front conditioned air generating device for generating conditioned air to be blown into the front air conditioning zone.

A rear air mix door (RrA/M door) 25 is provided upstream of the heater core 23 in the rear zone air passage 22. The rear air mix door 25 is configured to control a volume ratio of the air introduced to the heater core 23 to the air bypassing the heater core 23 in the rear zone air passage 22. In other words, the rear air mix door 25 controls a ratio of the heated air to the cooled air in the rear zone air passage 22. The rear air mix door 25 serves as a rear conditioned air generating device for generating conditioned air to be blown into the rear air conditioning zone.

The front air mix door 24 and the rear air mix door 25 are driven by actuators 26, 27, such as servomotors, respectively. Thus, the temperature of the air blown into the front air conditioning zone from the front outlets and the temperature of the air blown into the rear air conditioning zone from the rear outlets are independently controlled.

The evaporator 19 is a member of a refrigerant cycle. Although not illustrated, the refrigerant cycle generally includes a compressor, a condenser, a receiver, and an expansion valve, in addition to the evaporator 19.

The compressor is driven by the engine through an electromagnetic clutch. The compressor compresses refrigerant and feeds the compressed refrigerant toward the condenser. The condenser condenses and liquefies the compressed refrigerant. The receiver separates liquefied refrigerant into a gas phase refrigerant and a liquid phase refrigerant. The expansion valve adiabatically expands the liquid phase refrigerant flowing out from the receiver. The evaporator 19 evaporates a gas and liquid two-phase refrigerant flowing out from the expansion valve.

The a/c ECU 2 is electrically coupled to various sensors, such as an inside air temperature sensor 31, an outside air temperature sensor 33, a cooled air temperature sensor 34, and a cooling fluid sensor 35. The inside air temperature sensor 31 detects an inside air temperature Tr inside of the passenger compartment. The outside air temperature sensor 33 detects an outside air temperature Tam outside of the passenger compartment.

The cooled air temperature sensor 34 detects an evaporator-downstream air temperature Te, which is the temperature of cooled air having passed through the evaporator 19. The cooling fluid sensor 35 detects a cooling fluid temperature Tw, which is the temperature of the engine cooling fluid.

Further, the a/c ECU 2 is electrically coupled to an air conditioner operation panel 36 having various switches, such as an inside/outside air switch, an outlet mode switch, an air volume switch, an A/C switch, an auto-switch, a front temperature setting switch, a rear temperature setting switch and the like. The a/c ECU 2 receives switch signals produced in response to operations of the various switches of the air conditioner operation panel 36.

The inside/outside air switch, the outlet mode switch, the air volume switch, the A/C switch and the like are provided to manually control an air conditioning operation. The auto-switch is provided to conduct an automatic air conditioning control.

The front temperature setting switch is provided for setting the temperature of the front air conditioning zone to a desired temperature, which is hereinafter referred to as a front setting temperature TsetFr. The rear temperature setting switch is provided for setting the temperature of the rear air conditioning zone to a desired temperature, which is hereinafter referred to as a rear setting temperature TsetRr.

The a/c ECU 2 controls operations of the actuators 14, 18, 26, 27 and the like based on the signals outputted from the various sensors 31, 33, 34, 35 and the various switches of the air conditioner operation panel 36.

The a/c ECU 2 serves as a control unit and is constructed of a well-known microcomputer including a CPU, a ROM, a RAM and the like and peripheral circuits. The a/c ECU 2 executes various computations for conducting air conditioning operations based on control programs stored in the ROM. For example, the a/c ECU 2 is supplied with electric power from a battery (not shown) when an ignition switch (not shown) is turned on.

For example, in an air conditioning control in which an air volume level VM of the blower 13, 17 is determined based on a front target temperature FrTAOi, which is a target temperature of air blown into the front air conditioning zone, if a thermal load of the front air conditioning zone is greater or less than a thermal load of the rear air conditioning zone, the volume of air blown toward the rear conditioning zone is excessively increased or reduced. In such a case, it is difficult to provide a comfortable air conditioning environment.

In an air conditioning control, as described in JP-A-2006-111176, the volume of air is corrected based on a rear target temperature RrTAOi, which is a target temperature of air blown into the rear air conditioning zone. Air is blown toward the front air conditioning zone with the volume, which is corrected based on the rear target temperature RrTAOi. Therefore, a front passenger may feel uncomfortable.

Further, in a case where the air volume level VM of the blower 13, 17 is determined based on the front setting temperature TsetFr, the rear setting temperature TsetRr will not be appropriately reflected in setting of the air volume level.

In the present embodiment, therefore, the a/c ECU 2 calculates a reference air volume level VMd based on the front target temperature FrTAOi and corrects the reference air volume level VMd in accordance with a deviation between the front target temperature FrTAOi and the rear target temperature RrTAOi.

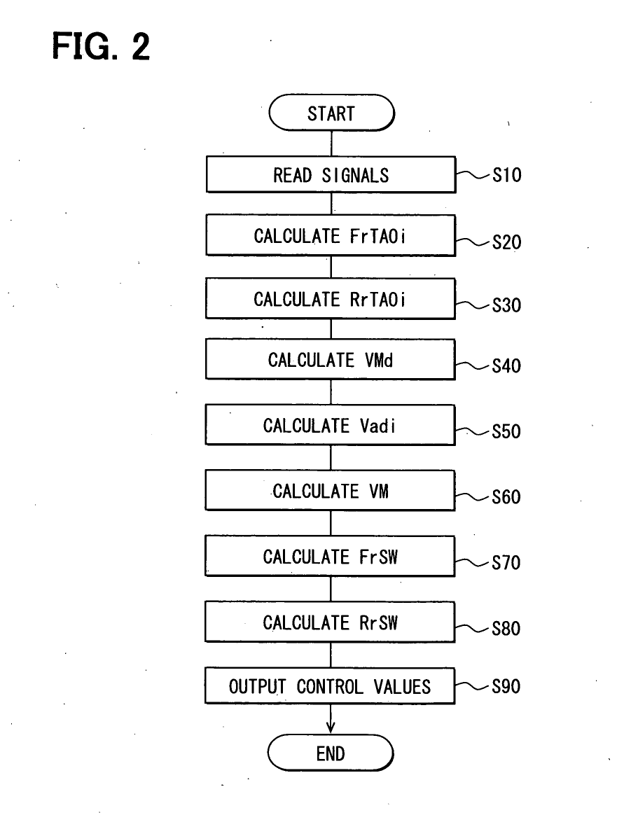

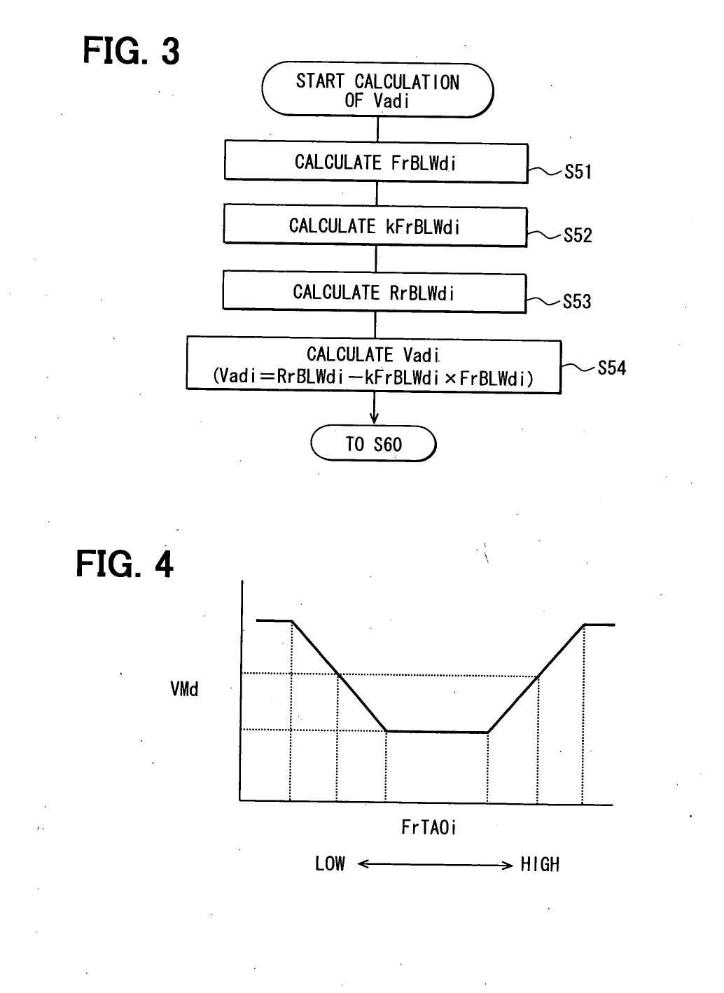

Next, a characteristic operation of the present embodiment will be described with reference to flowcharts of FIGS. 2 and 3. The flowchart of FIG. 2 represents a basic routine of an automatic air conditioning control executed by the a/c ECU 2. The basic routine begins as the auto-switch is turned on.

At S10, the signals outputted from the various sensors 31, 33, 34, 35 and the various switches of the air conditioner operation panel 36 are read.

At S20, the front target temperature FrTAOi is calculated. The front target temperature FrTAOi corresponds to a target temperature of air blown toward the front air conditioning zone through the front zone air passage 21. The front target temperature FrTAOi is an air temperature required to retain the temperature of the front air conditioning zone to the front setting temperature TsetFr, which is set by the front temperature setting switch, irrespective to a change in air conditioning thermal load.

The front target temperature FrTAOi is given based on the following equation (1) using the front setting temperature TsetFr, the inside air temperature Tr and the outside air temperature Tam:

FrTAOi=Kset×TsetFr−Kr×Tr−Kam×Tam+CFr (1)

in which Kset, Kr and Kam represent control gains, and CFr represents a correction constant.

At S30, the rear target temperature RrTAOi is calculated. The rear target temperature RrTAOi corresponds to a target temperature of air blown toward the rear air conditioning zone through the rear zone air passage 22. The rear target temperature RrTAOi is an air temperature required to retain the temperature of the rear air conditioning zone to the rear setting temperature TsetRr, which is set by the rear temperature setting switch, irrespective to a change in air conditioning thermal load.

The rear target temperature RrTAOi is given based on the following equation (2) using the rear setting temperature TsetRr, the inside air temperature Tr and the outside air temperature Tam:

RrTAOi=Kset×TsetRr−Kr×Tr−Kam×Tam+CRr (2)

in which Kset, Kr and Kam represent control gains and CRr is a correction constant.

At S40, the reference air volume level VMd is calculated. The reference volume level VMd is a provisional control value (voltage) applied to the blower 13, 17 for generating air blown into the front air conditioning zone and the rear air conditioning zone. The reference volume level VMd corresponds to an air volume Va that is the sum of a front air volume VaFr to be supplied into the front air conditioning zone and a rear air volume VaRr to be supplied into the rear air conditioning zone. Thus, air is blown into each of the front air conditioning zone and the rear air conditioning zone at an average volume of the front air volume VaFr and the rear air volume VaRr, that is, at a volume of (VaFr+VaRr)/2.

In the present embodiment, the reference air volume level VMd is given based on the front target temperature FrTAOi calculated at S20. The reference air volume level VMd is determined based on a diagram of FIG. 4, which illustrates a relationship between the front target temperature FrTAOi and the reference air volume level VMd. That is, the provisional control value applied to the blower 13 can be determined in accordance with the determination of the front target temperature FrTAOi.

The provisional control value corresponds to the sum of the front air volume VaFr and the rear air volume VaRr. Because the reference air volume level VMd is an air volume level corresponding to the air volume Va introduced into the duct 11 the reference air volume level VMd can be obtained from the air volume Va calculated from the following equation (3):

Va=VaFr+VaRr (3)

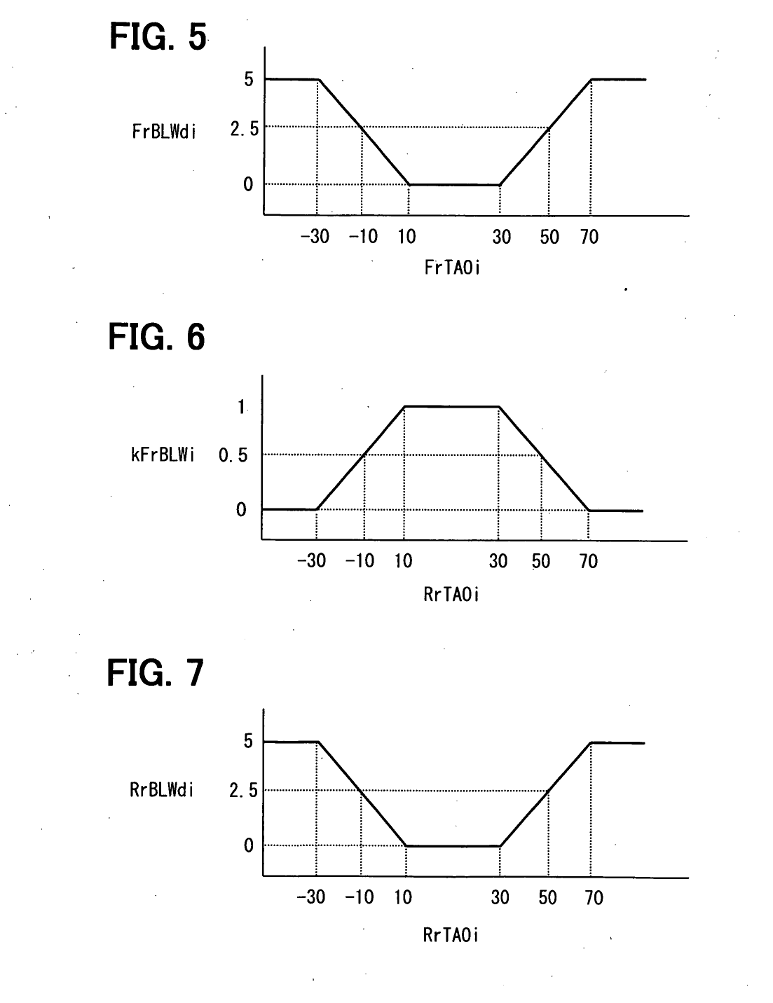

The diagram shown in FIG. 4 is stored as a map in the ROM. Likewise, diagrams shown in FIGS. 5 to 7 are stored in the ROM.

At S50, a correction air volume level Vadi is calculated. Here, the correction air volume level Vadi is calculated in accordance with the deviation between the front target temperature FrTAOi and the rear target temperature RrTAOi. The correction air volume level Vadi corresponds to the correction amount for correcting the reference air volume level VMd calculated at S40.

For example, the correction air volume level Vadi is calculated in accordance with the flowchart shown in FIG. 3. Correction terms are calculated through S51 to S53.

At S51, a front air volume level correction term FrBLWdi is calculated based on the front target temperature FrTAOi. Here, the front air volume level correction term FrBLWdi is determined using the diagram of FIG. 5, which shows a relationship between the front target temperature FrTAOi and the front air volume level correction term FrBLWdi. For example, when the front target temperature FrTAOi is 50, the front air volume level correction term FrBLWdi is 2.5.

At S52, a gain correction term kFrBLWdi is calculated in accordance with a condition of the rear target temperature RrTAOi. For example, the gain correction term kFrBLWdi is determined using the diagram of FIG. 6, which shows a relationship between the rear target temperature RrTAOi and the gain correction term kFrBLWdi. For example, when the rear target temperature RrTAOi is 30, the gain correction term kFrBLWdi is 1.

At S53, a rear air volume level correction term RrBLWdi is calculated in accordance with a condition of the rear target temperature RrTAOi. For example, the rear air volume level correction term RrBLWdi is determined using the diagram of FIG. 7, which shows a relationship between the rear target temperature RrTAOi and the rear air volume level correction term RrBLWdi. For example, when the rear target temperature RrTAOi is 30, the rear air volume level correction term RrBLWdi is 0.

At S54, the correction air volume level (the correction amount) Vadi is calculated using the correction terms obtained at S51 to S53. The correction air volume level Vadi is given based on the following equation (4):

Vadi=RrBLWdi−kFrBLWdi×FrBLWdi (4)

As such, the correction air volume level Vadi can be calculated in accordance with the deviation between the front target temperature FrTAOi and the rear target temperature RrTAOi.

For example, when the front target temperature FrTAOi is 50 and the rear target temperature RrTAOi is 30, the deviation therebetween is 20. Thus, the correction air volume level Vadi is −2.5 (i.e., Vadi=0−1×2.5=−2.5). When the thermal load of the front air conditioning zone is high and the thermal load of the rear air conditioning zone is low as in this example, the correction air volume level Vadi is a negative value.

On the other hand, when the front target temperature FrTAOi is 30 and the rear target temperature RrTAOi is 50, the correction air volume level Vadi is determined to 2.5 (i.e., Vadi=2.5−0.5×0=2.5). When the thermal load of the front air conditioning zone is low and the thermal load of the rear air conditioning zone is high as in this example, the correction air volume level Vadi is a positive value.

At S60, the air volume level VM is calculated. The air volume level VM is calculated to obtain the control value to be outputted to the blower 13, 17. Here, the reference air volume level VMd, which is the provisional control value calculated at S40, is corrected in accordance with the correction air volume level Vadi.

For example, the air volume level VM is calculated based on the following equation (5):

VM=VMd+Vadi (5)

As described above, when the correction air volume level Vadi calculated at S50 is a negative value, the air volume level VM is obtained by deducting the amount of the correction air volume level Vadi from the reference air volume level VMd. That is, the reference air volume level VMd is corrected by a reduction manner. On the other hand, when the correction air volume level Vadi is a positive value, the air volume level VM is obtained by adding the amount of the correction air volume level Vadi to the reference air volume level VMd. That is, the VMd is corrected by an increase manner.

The smaller the deviation between the front target temperature FrTAOi and the rear target temperature RrTAOi is, the smaller the correction air volume level Vadi is. The larger the deviation between the front target temperature FrTAOi and the rear target temperature RrTAOi is, the larger the correction air volume level Vadi is.

At S70, an opening degree FrSW of the front air mix door 24 is calculated. Here, the opening degree FrSW of the front air mix door 24 is specified by a percentage of an air mixing ratio of the heated air to the cooled air. When the front air mix door 24 is in a front max cool position at which a front heated air passage communicating with the heater core 23 in the front zone air passage is fully closed and a front cooled air passage bypassing the heater core 23 in the front zone air passage 21 is fully open, the opening degree FrSW is defined as 0%. When the front air mix door 24 is in a front max hot position at which the front heated air passage is fully open and the front cooled air passage is fully closed, the opening degree FrSW is defined as 100%.

The opening degree FrSW of the front air mix door 24 is given based on the following equation (6) using the front target temperature FrTAOi, the evaporator-downstream air temperature Te and the cooling fluid temperature Te:

FrSW=(FrTAOi−Te)/(Tw−Te)×100% (6)

The temperature of air blown into the front air conditioning zone is controlled in accordance with the opening degree FrSW of the front air mix door 24.

At S80, an opening degree RrSW of the rear air mix door 25 is calculated. The opening degree RrSW of the rear air mix door 25 is specified by a percentage, similarly to the opening degree FrSW of the front air mix door 24.

The opening degree RrSW is given based on the following equation (7) using the rear target temperature RrTAOi, the evaporator-downstream air temperature Te and the cooling fluid temperature Te:

RrSW=(RrTAOi−Te)/(Tw−Te)×100% (7)

The temperature of air blown into the rear air conditioning zone is controlled in accordance with the opening degree RrSW of the rear air mix door 25.

At S90, the air volume level VM calculated at S60 and the opening degrees FrSW, RrSw calculated at S70, S80 are outputted as the control values. As such, the voltage corresponding to the corrected air volume level VM is applied to the blower 13. Further, the front air mix door 24 and the rear air mix door 25 are respectively operated to the predetermined positions, that is, operated to the calculated opening degrees FrSW, RrSW. Accordingly, the temperature of air to be introduced into the front air conditioning zone and the temperature of air to be introduced into the rear air conditioning zone are respectively controlled. Thus, conditioned air having a predetermined temperature is blown into each of the front air conditioning zone and the rear air conditioning zone.

As described above, the air volume level VM is determined by correcting the reference air volume level VMd, which is calculated based on the front target temperature FrTAOi, by the correction air volume level Vadi, which is calculated in accordance with the deviation between the front target temperature FrTAOi and the rear target temperature RrTAOi. That is, the control value outputted to the blower 13, 17 is corrected in accordance with the conditions of the front target temperature FrTAOi and the rear target temperature RrTAOi. As such, the volume of air blown into the rear air conditioning zone is properly controlled, and a comfortable air conditioning environment can be created. Thus, an air conditioning feeling of the rear air conditioning zone improves without deteriorating an air conditioning feeling of the front air conditioning zone.

In the case where the thermal load of the front air conditioning zone is lower than the thermal load of the rear air conditioning zone, the reference air volume level VMd is corrected in the increase manner. In the case where the thermal load of the front air conditioning zone is higher than the thermal load of the rear air conditioning zone, the reference air volume level VMd is corrected in the reduction manner. Therefore, comfortable air conditioning zones can be created without excessively increasing or reducing the volume of air blown into the rear air conditioning zone.

The correction air volume level Vadi reduces as the deviation between the front target temperature FrTAOi and the rear target temperature RrTAOi reduces. The correction air volume Vadi increases as the deviation between the front target temperature FrTAOi and the rear target temperature RrTAOi increases. Therefore, the volume of air introduced into the rear air conditioning zone can be controlled appropriately. As such, the rear passenger will not feel that the volume of air is excessively large or excessively small.

### Second Embodiment

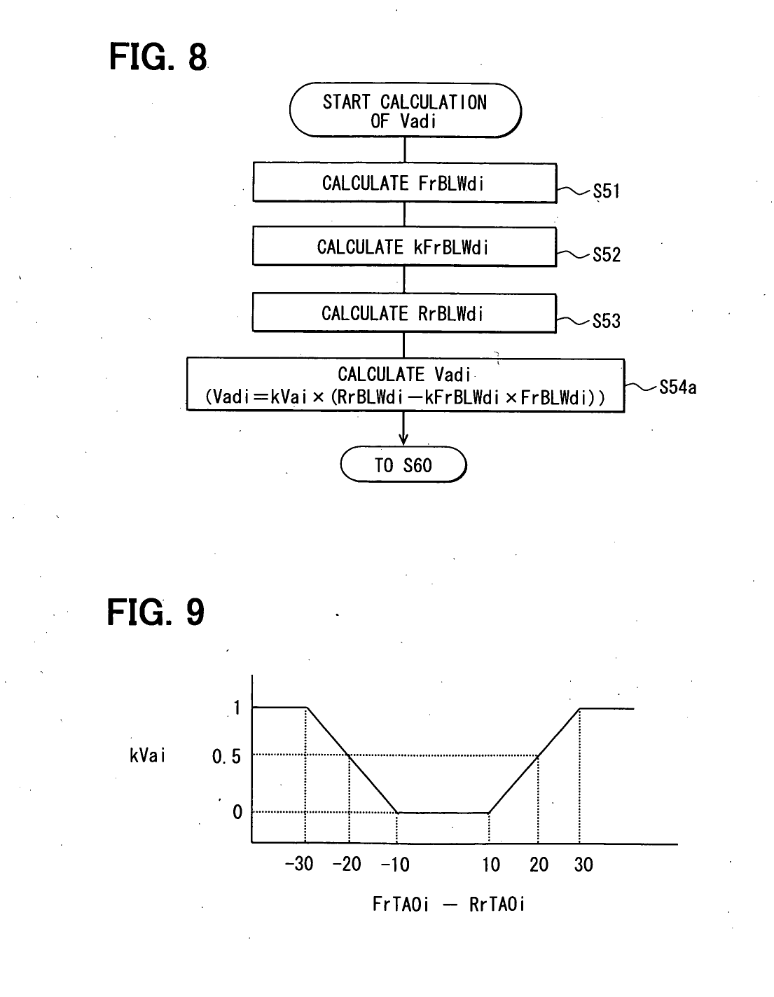

A second embodiment will be described with reference to FIGS. 8 and 9. In the present embodiment, the correction air volume level Vadi can be calculated using a gain correction term kVai obtained in accordance with the deviation between the front target temperature FrTAOi and the rear target temperature RrTAOi. FIG. 8 shows a flowchart illustrating a procedure for calculating the correction air volume level Vadi of the present embodiment, and FIG. 9 is a diagram for obtaining the gain correction term kVai.

Referring to FIG. 8, at S54a, the correction air volume level Vadi is calculated based on the following equation (8):

Vadi=kVai×(RrBLWdi−kFrBLWdi×FrBLWdi) (8)

That is, the correction air volume level Vadi is given by multiplying each of correction terms calculated at S51, S52, S53 by the gain correction term kVai. The gain correction term kVai is calculated in accordance with the deviation between the front target temperature FrTAOi and the rear target temperature RrTAOi.

For example, the gain correction term kVai is determined based on the diagram of FIG. 9, which shows a relationship between the deviation between the front target temperature FrTAOi and the rear target temperature RrTAOi (i.e., FrTAOi−RrTAOi) and the gain correction term kVai. For example, when the front target temperature FrTAOi is 30 and the rear target temperature RrTAOi is 50, the deviation is −20. Thus, the gain correction term kVai is 0.5.

In the first embodiment, for example, when the front target temperature FrTAOi is 30 and the rear target temperature RrTAOi is 50, the correction air volume level Vadi calculated at S54 based on the equation (4) is +2.5 (i.e., RrBLWdi−kFrBLWdi×FrBLWdi=+2.5). In the present embodiment, the correction air volume level Vadi is obtained by multiplying the gain correction term kVai determined based on the diagram of FIG. 9 (e.g., 0.5) and the correction air volume level given by the equation (4) (e.g., +2.5). Thus, the correction air volume level Vadi is +1.25.

In this way, in a case where the thermal load of the front air conditioning zone is relatively high and the thermal load of the rear air conditioning zone is higher than the thermal load of the front air conditioning zone, the correction amount Vadi is reduced. Thus, the amount of increase in the air volume level VM at S60 is reduced.

For example, when the front target temperature FrTAOi is 50 and the rear target temperature RrTAOi is 30, the deviation therebetween (i.e., FrTAOi−RrTAOi) is 20, and the gain correction term kVai is 0.5. In the first embodiment, for example, when the front target temperature FrTAOi is 50 and the rear target temperature RrTAOi is 30, the correction air volume level Vadi calculated at S54 based on the equation (4) is −2.5 (i.e., RrBLWdi−kFrBLWdi×FrBLWdi=−2.5).

In the present embodiment, the correction air volume level Vadi is obtained by multiplying the gain correction term kVai determined using the diagram of FIG. 9 (e.g., 0.5) and the correction air volume level given by the equation (4) (e.g., −2.5). Thus, the correction air volume level Vadi of the present embodiment is −1.25. In this way, when the thermal load of the front air conditioning zone is relatively high and the thermal load of the rear air conditioning zone is smaller than the thermal load of the rear air conditioning zone, the correction amount Vadi is reduced. Thus, the amount of decrease in the air volume level VM at S60 is reduced.

In this way, when the thermal load of the front air conditioning zone is relatively high, the correction amount Vadi can be reduced by using the gain correction term kVai, which is calculated based on the deviation between the front target temperature FrTAOi and the rear target temperature RrTAOi.

In this case, the control value applied to the blower 13, 17 is corrected in accordance with the conditions of the front target temperature FrTAOi and the rear target temperature RrTAOi. Therefore, a comfortable air conditioning environment can be created, and it is less likely that a rear passenger feel that the volume of air is excessively large or excessively small. An air conditioning feeling of the rear air conditioning zone improves without deteriorating an air conditioning feeling of the front air conditioning zone.

### Third Embodiment

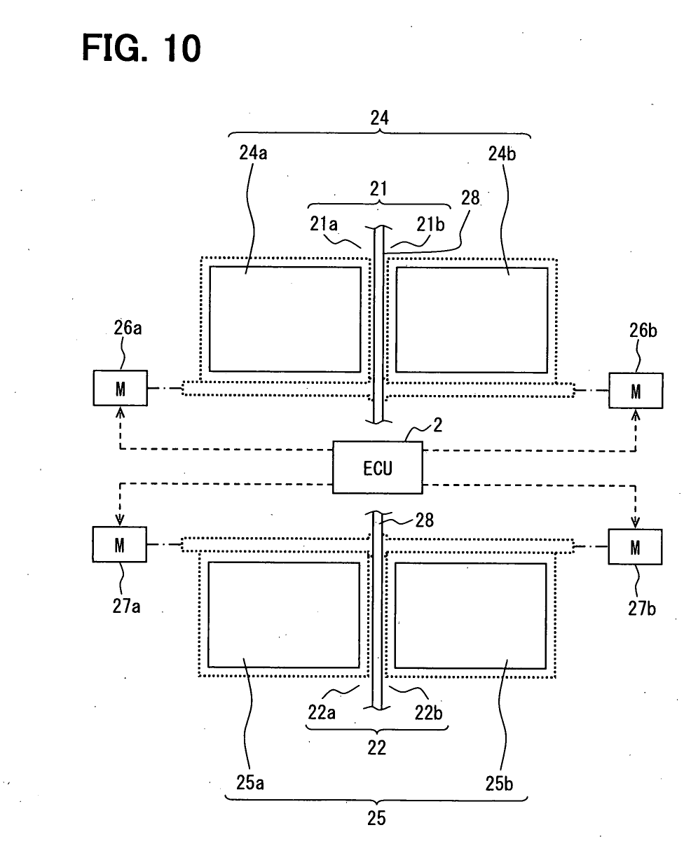

A third embodiment will be described with reference to FIGS. 10, 11, and 12. In the first and second embodiments, the air conditioning apparatus exemplarily has a function of independently controlling the temperature of air to be blown into the front air conditioning zone and the temperature of air to be blown into the rear air conditioning zone. In the present embodiment, the air conditioning apparatus further has a function of conducting automatic and independent air conditioning controls for right and left areas of the front air conditioning zone and right and left areas of the rear air conditioning zone.

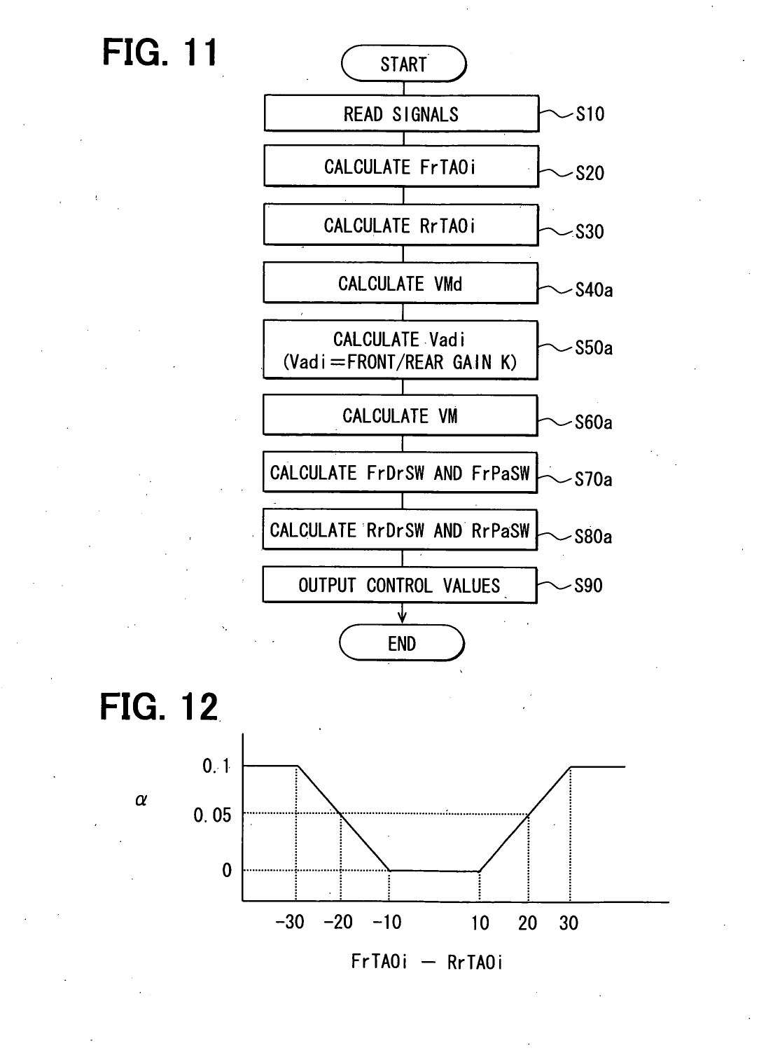

FIG. 10 is a diagram illustrating arrangements of the front air mix door 24 and the rear air mix door 25, each of which is divided into a right section and a left section. FIG. 11 is a flowchart illustrating a basic routine of an automatic air conditioning control executed by the a/c ECU 2 of the present embodiment. FIG. 12 is a diagram for determining a variable coefficient α.

Referring to FIG. 10, the duct 11 has a separation wall 28. The separation wall 28 is, for example, disposed at a substantially middle position of the front and rear zone air passages 21, 22, which are provided downstream of the evaporator 19, with respect to a vehicle right and left direction. The front zone air passage 21 is separated into a front left air passage 21a and a front right air passage 21b by the separation wall 28. Likewise, the rear zone air passage 22 is separated into a rear left air passage 22a and a rear right air passage 22b by the separation wall 28.

Air passing through the front left air passage 21a is blown into a front left air conditioning zone, and air passing through the front right air passage 21b is blown into a front right air conditioning zone. Likewise, air passing through the rear left air passage 22a is blown into a rear left air conditioning zone, and air passing through the rear right air passage 22b is blown into a rear right air conditioning zone.

For example, in a case where the air conditioning apparatus is employed to a right-hand-drive vehicle, the front and rear right air passages 21b, 22b correspond to driver seat side air passages, and the front and rear left air passages 21a, 22a correspond to front passenger seat side air passages (i.e., assistant driver seat side air passages).

Since the separation wall 28 is arranged, the front air mix door 24 is separated into a front left door 24a and a front right door 24b. Likewise, the rear air mix door 25 is separated into a rear left door 25a and a rear right door 25b. For example, the front left door 24a can be also referred to as a front passenger seat side door or a FrPaA/M door, and the front right door 24b can be also referred to as a front driver seat side door or a FrDrA/M door. Likewise, the rear left door 25a can be also referred to as a rear front-passenger seat side door or a RrPaA/M door, and the rear right door 25b can be also referred to as a rear driver seat side door or a RrDrA/M door.

Also, the front left door 24a serves as a front-left conditioned air generating device and the front right door 24b serves as a front-right conditioned air generating device. Likewise, the rear left door 25a serves as a rear-left conditioned air generating device and the rear right door 25b serves as a rear-right conditioned air generating device.

Rotation shafts of the doors 24a, 24b, 25a, 25b are coupled to actuators 26a, 26b, 27a, 27b, such as servomotors, respectively. The actuators 26a, 26b, 27a, 27b are electrically connected to the a/c ECU 2. Operations of the doors 24a, 24b, 25a, 25b can be controlled in accordance with setting temperatures Tset, which are set through a front left temperature setting switch, a front right temperature setting switch, a rear left temperature setting switch and a rear right temperature setting switch, respectively.

Further, the outlet ports are provided at the downstream locations of the front left and right air passages 21a, 21b and the rear left and right air passages 22a, 22b for blowing air into the front left air conditioning zone, the front right air conditioning zone, the rear left air conditioning zone and the rear right air conditioning zone, respectively. Accordingly, the temperature of air blown into each of the front left air conditioning zone, the front right air conditioning zone, the rear left air conditioning zone and the rear right air conditioning zone can be independently controlled.

Next, an air conditioning control conducted by the air conditioning apparatus of the present embodiment will be described with reference to a flowchart of FIG. 11. S10, S20, S30 and S90 are performed in the similar manner as those of FIG. 2.

At S40a, a reference air volume level VMd is calculated as a provisional control value (voltage) to be applied to the blower 13, 17 for generating air blown into the front left and right air conditioning zones and the rear left and right air conditioning zones.

In this case, the reference air volume level VMd corresponds to an air volume Va that is the sum of an air volume VaFrPa to be blown into the front left air conditioning zone, an air volume VaFrDr to be blown into the front right air conditioning zone, an air volume VaRrPa to be blown into the rear left air conditioning zone and an air volume VaRrDr to be blown into the rear right air conditioning zone. Air is blown into each of the front left air conditioning zone, the front right air conditioning zone, the rear left air conditioning zone and the rear right air conditioning zone at the average volume of the air volumes VaFrPa, VaFrDr, VaRrPa, VaRrDr, that is, at the volume of (VaFrDr+VaRrDr+VaRrDr+VaRrPa)/4.

Also in the present embodiment, the reference air volume level VMd is calculated based on the front target temperature FrTAOi, which is calculated at S20. The reference air volume level VMd is determined using the diagram shown in FIG. 4. For example, the provisional control value to be applied to the blower 13, 17 can be calculated by determining the front target temperature FrTAOi.

The reference air volume level VMd is a level corresponding to the air volume Va to be introduced into the duct 11. Therefore, the reference air volume level VMd can be calculated based on the air volume Va, which is given from the following equation (9):

Va=VaFrDr+VaFrPa+VaRrDr+VaRrPa (9)

At S50, the correction air volume level (the correction amount) Vadi is calculated. In the present embodiment, the correction air volume level Vadi is determined by front and rear gains K associated to the front and rear air conditioning zones. The front and rear gains K are calculated in accordance with the deviation between the front target temperature FrTAOi and the rear target temperature RrTAOi.

When the thermal load of the front air conditioning zone is low and the thermal load of the rear air conditioning zone is high, the front gain K is corrected to an increased correction (increased gain) K1 for increasing the air volumes corresponding to the front air conditioning zone, and the rear gain K is corrected to a reduced correction (reduced gain) K2 for reducing the air volumes corresponding to the rear air conditioning zone. The correction air volume level Vadi corresponds to the increased correction K1 and the reduced correction K2.

When the thermal load of the front air conditioning zone is high and the thermal load of the rear air conditioning zone is low, the front gain K is corrected to the reduced correction K2 for reducing the air volumes corresponding to the front air conditioning zone, and the rear gain K is corrected to the increased correction K1 for increasing the air volumes corresponding to the rear air conditioning zone. The correction air volume level Vadi corresponds to the increased correction K1 and the reduced correction K2.

The increased correction K1 is obtained by adding a variable coefficient α to the normal gain K (e.g., 0.25). The reduced correction K2 is obtained by deducting the variable coefficient α from the normal gain K (e.g., 0.25). Here, the coefficient α is variable in accordance with the deviation between the front target temperature FrTAOi and the rear target temperature RrTAOi.

For example, the variable coefficient α can be determined based on the diagram shown in FIG. 12. For example, when the front target temperature FrTAOi is 30 and the rear target temperature RrTAOi is 50, the deviation therebetween (i.e., FrTAOi−RrTAOi) is −20. Thus, the variable coefficient α is 0.05. As another example, when the front target temperature FrTAOi is 50 and the rear target temperature RrTAOi is 30, the deviation therebetween (i.e., FrTAOi−RrTAOi) is 20. Thus, the variable coefficient α is 0.05. As such, the increased correction K1 is given by the equation of K1=K+α, and the reduced correction K2 is given by the equation of K2=K−α.

At S60a, the air volume level VM is calculated. The reference air volume level VMd calculated at S40a is corrected using the correction air volume level calculated at S50a. The air volume level VM is given by the following equation (10):

VM=K×VaFrDr+K×VaFrPa+K×VaRrDr+K×VaRrPa (10)

in which K represents the gain associated to the front right air conditioning zone, the front left air conditioning zone, the rear right air conditioning zone and the rear left air conditioning zone.

The gain K is corrected in accordance with the deviation between the front target temperature FrTAOi and the rear target temperature RrTAOi. When the thermal load of the front air conditioning zone is low and the thermal load of the rear air conditioning zone is high, the air volume level VM is given by the following equation (10-1):

VM=K1×VaFrDr+K1×VaFrPa+K2×VaRrDr+K2×VaRrPa (10-1)

On the other hand, when the thermal load of the front air conditioning zone is high and the thermal load of the rear air conditioning zone is low, the air volume level VM is given by the following equation (10-2):

VM=K2×VaFrDr+K2×VaFrPa+K1×VaRrDr+K1×VaRrPa (10-2)

When the thermal load of the front air conditioning zone is low and the thermal load of the rear air conditioning zone is high, the air volumes VaFrDr, VaFrPa are corrected by the increased correction K1, and the air volume VaRrDr, VaRrPa are corrected by the reduced correction K2. Therefore, it is less likely that the volumes of air blown toward the front air conditioning zone and the rear air conditioning zone will be excessively increased or reduced. Accordingly, comfortable air conditioning environments can be created.

Likewise, when the thermal load of the front air conditioning zone is high and the thermal load of the rear air conditioning zone is low, the air volumes VaFrDr, VaFrPa are corrected by the reduced correction K2, and the air volumes VaRrDr, VaRrPa are corrected by the increased correction K1. Also in this situation, it is less likely that the volumes of air blown toward the front air conditioning zone and the rear air conditioning zone will be excessively increased or reduced. Accordingly, comfortable air conditioning environments can be created.

At S70a, an opening degree FrDrSW of the front right air mix door 24b and an opening degree FrPaSW of the front left air mix door 24a are calculated. The opening degrees FrDrSW and FrPaSW are given by the following equations (11) and (12), respectively:

FrDrSW=(FrDrTAO−Te)/(Tw−Te)×100% (11)

FrPaSW=(FrPaTAO−Te)/(Tw−Te)×100% (12)

In the above equation (11), FrDrTAO corresponds to a target air temperature of the front right air conditioning zone, and is calculated based on the front right setting temperature TsetFrDr. In the above equation (12), FrPaTAO corresponds to a target air temperature of the front left air conditioning zone, and is calculated based on the front left setting temperature TsetFrPa. Accordingly, the temperature of air blown into the front right air conditioning zone and the temperature of air blown into the front left air conditioning zone are independently controlled.

At S80a, an opening degree RrDrSW of the rear right air mix door 25b and an opening degree RrPaSW of the rear left air mix door 25a are calculated. Here, the opening degrees RrDrSW and RrPaSW are given by the following equations (13) and (14), respectively:

RrDrSW=(RrDrTAO−Te)/(Tw−Te)×100% (13)

RrPaSW=(RrPaTAO−Te)/(Tw−Te)×100% (14)

Accordingly, the temperature of air blown into the rear right air conditioning zone and the temperature of air blown into the rear left air conditioning zone are independently controlled.

As described above, the air volume level VM is obtained by correcting the reference air volume level VMd by the front and rear gains K as the correction air volume level Vadi, which are calculated based on the deviation between the front target temperature FrTAOi and the rear target temperature RrTAOi. That is, the control value outputted to the blower 13, 17 is corrected in accordance with the conditions of the front target temperature FrTAOi and the rear target temperature RrTAOi. Accordingly, comfortable air conditioning environments can be created without excessively increasing or reducing the air volumes to the front air conditioning zone and the rear air conditioning zone.

When the thermal load of the front air conditioning zone is low and the thermal load of the rear air conditioning zone is high, or when the thermal load of the front air conditioning zone is high and the thermal load of the rear air conditioning zone is low, the air volume corresponding to the zone having the lower thermal load is corrected by the increased correction K1 and the air volume corresponding to the zone having the higher thermal load is corrected by the reduced correction K2. Therefore, it is less likely that the volumes of air to the front air conditioning zone and the rear air conditioning zone will be excessively increased or reduced. Accordingly, comfortable air conditioning zones can be created.

### Other Embodiments

In the above embodiments, the front air mix door 24 and the rear air mix door 25 are exemplarily constructed of rotatable plate doors. However, the doors 24, 25 can be constructed of any other types of doors, such as a slide door including a plastic film, which is slidable along a sealing surface provided in the duct 11.

Additional advantages and modifications will readily occur to those skilled in the art. The invention in its broader term is therefore not limited to the specific details, representative apparatus, and illustrative examples shown and described.

What is claimed is:

1. An air conditioning apparatus for a vehicle having a passenger compartment including a front air conditioning zone and a rear air conditioning zone, comprising:
a duct;
a blower for generating air into the duct;
a heating device disposed in the duct for generating heated air;
a cooling device disposed in the duct for generating cooled air;
a front conditioned air generating device disposed in the duct and configured to control a ratio of the heated air to the cooled air for generating a front conditioned air to be introduced into the front air conditioning zone;
a rear conditioned air generating device disposed in the duct and configured to control a ratio of the heated air to the cooled air for generating a rear conditioned air to be introduced into the rear air conditioning zone; and
a control unit for controlling the blower, the front conditioned air generating device, the rear conditioned air generating device, the control unit including:
front target temperature calculating means for calculating a front target temperature, which is a target temperature of the front conditioned air;
rear target temperature calculating means for calculating a rear target temperature, which is a target temperature of the rear conditioned air;
reference air volume level calculating means for calculating a reference air volume level of the blower based on the front target temperature; and
correction air volume level calculating means for calculating a correction amount for correcting the reference air volume level based on a deviation between the front target temperature and the rear target temperature.

2. The air conditioning apparatus according to claim 1, wherein
the control unit further includes air volume level calculating means for calculating an air volume level of the blower using the correction amount,
when a thermal load of the front air conditioning zone is lower than a thermal load of the rear air conditioning zone, the air volume level calculating means calculates the air volume level by adding the correction amount to the reference air volume level, and
when the thermal load of the front air conditioning zone is higher than a thermal load of the front air conditioning zone, the air volume level calculating means calculates the air volume level by subtracting the correction amount from the reference air volume level.

3. The air conditioning apparatus according to claim 1, wherein
the correction air volume level calculating means reduces the correction amount in accordance with a reduction in the deviation between the front target temperature and the rear target temperature and increases the correction amount in accordance with an increase in the deviation between the front target temperature and the rear target temperature.

4. The air conditioning apparatus according to claim 1, wherein
the correction air volume level calculating means includes:
gain correction term calculating means for calculating a gain correction term based on the deviation between the front target temperature and the rear target temperature; and
gain correction term multiplying means for multiplying the gain correction term and the correction amount.

5. An air conditioning apparatus for a vehicle having a passenger compartment with a front air conditioning zone including a right area and a left area and a rear air conditioning zone including a right area and a left area, the air conditioning apparatus comprising:
a duct;
a blower for generating air into the duct;
a heating device disposed in the duct for generating heated air;
a cooling device disposed in the duct for generating cooled air;
a front-right conditioned air generating device disposed in the duct and configured to control a ratio of the heated air to the cooled air for generating a front-right conditioned air to be introduced into the right area of the front air conditioning zone;
a front-left conditioned air generating device disposed in the duct and configured to control a ratio of the heated air to the cooled air for generating a front-left conditioned air to be introduced into the left area of the front air conditioning zone;
a rear-right conditioned air generating device disposed in the duct and configured to control a ratio of the heated air to the cooled air for generating a rear-right conditioned air to be introduced into the right area of the rear air conditioning zone;
a rear-left conditioned air generating device disposed in the duct and configured to control a ratio of the heated air to the cooled air for generating a rear-left conditioned air to be introduced into the left area of the rear air conditioning zone; and
a control unit for controlling the blower, the front-right conditioned air generating device, the front-left conditioned air generating device, the rear-right conditioned air generating device and the rear-left conditioned air generating device, the control unit including:
front target temperature calculating means for calculating a front target temperature, which is a target temperature of the front-right conditioned air and the front-left conditioned air;
rear target temperature calculating means for calculating a rear target temperature, which is a target temperature of the rear-right conditioned air and the rear-left conditioned air;
reference air volume level calculating means for calculating a reference air volume level of the blower based on the front target temperature;
correction air volume level calculating means for calculating a correction amount for correcting the reference air volume level based on a deviation between the front target temperature and the rear target temperature.

6. The air conditioning apparatus according to claim 5, wherein
the correction air volume level calculating means determines the correction amount by a front gain associated with the front air conditioning zone and a rear gain associated with the rear air conditioning zone.

7. The air conditioning apparatus according to claim 6, wherein
the correction air volume level calculating means corrects the front gain in an increase manner and corrects the rear gain in a reduce manner, when a thermal load of the front air conditioning zone is lower than a first predetermined load and a thermal load of the rear air conditioning zone is higher than a second predetermined load.

8. The air conditioning apparatus according to claim 7, wherein
the front gain is increased by adding a coefficient, and the rear gain is reduced by subtracting the coefficient, the coefficient being variable in accordance with the deviation between the front target temperature and the rear target temperature.

9. The air conditioning apparatus according to claim 6, wherein
the correction air volume level calculating means corrects the front gain in a reduce manner and corrects the rear gain in an increase manner when a thermal load of the front air conditioning zone is higher than a first predetermined load and a thermal load of the rear air conditioning zone is lower than a second predetermined load.

10. The air conditioning apparatus according to claim 9, wherein
the front gain is reduced by subtracting a coefficient, and the rear gain is increased by adding the coefficient, the coefficient being variable in accordance with the deviation between the front target temperature and the rear target temperature.

11. A method of conducting an air conditioning control for a passenger compartment of a vehicle, comprising:
calculating a front target temperature of air to be blown into a front air conditioning zone of the passenger compartment;
calculating a rear target temperature of air to be blown into a rear air conditioning zone of the passenger compartment;
calculating a reference air volume level of a blower based on the front target temperature;
calculating a correction amount for correcting the reference air volume level based on a deviation between the front target temperature and the rear target temperature;
calculating an air volume level of the blower by correcting the reference air volume level using the correction amount;
calculating an opening degree of a front air mix door using the front target temperature;
calculating an opening degree of a rear air mix door using the rear target temperature;
controlling the blower to a calculated air volume level; and
controlling the front and rear air mix doors to calculated opening degrees.

12. The method according to claim 11, wherein
the calculating of the air volume level including:
adding the correction amount to the reference air volume level when a thermal load of the front air conditioning zone is lower than a thermal load of the rear air conditioning zone, and
subtracting the correction amount from the reference air volume level when the thermal load of the front air conditioning zone is higher than the thermal load of the rear air conditioning zone.

13. The method according to claim 11, wherein
the calculating of the reference air volume level includes:
calculating a gain correction term based on a deviation between the front target temperature and the rear target temperature; and
multiplying the gain correction term and the correction amount.

14. The method according to claim 11, wherein
the calculating of the reference air volume level includes:
determining the correction amount by a front gain associated to the front air conditioning zone and a rear gain associated to the rear air conditioning zone;
correcting the front gain and the rear gain by adding and subtracting a coefficient, respectively, when a thermal load of the front air conditioning zone is lower than a first predetermined load and a thermal load of the rear air conditioning zone is higher than a second predetermined load, and
correcting the front gain and the rear gain by subtracting and adding the coefficient, respectively, when the thermal load of the front air conditioning zone is higher than the first predetermined load and the thermal load of the rear air conditioning zone is lower than the second predetermined load,
the coefficient being variable in accordance with the deviation between the front target temperature and the rear target temperature.
